(19) United States
(12) Patent Application Publication
(10) Pub. No.: US 2005/0105910 A1
(43) Pub. Date: May 19, 2005

(54) Optical transceiver with integrated feedback device

(76) Inventor: Greta Light, San Mateo, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/829,742

(22) Filed: Apr. 22, 2004

Related U.S. Application Data
(60) Provisional application No. 60/520,896, filed on Nov. 17, 2003.

(51) Int. Cl. H04B 10/00

(52) U.S. Cl. 398/137

(57) ABSTRACT

A transceiver module is provided that includes a transceiver housing having disposed therein a transceiver substrate to which one or more OSAs are mounted. The transceiver substrate is substantially perpendicular to a longitudinal axis defined by the OSA. One or more feedback devices, such as LEDs, are mounted the transceiver substrate so as to be visible to a user by way of a connector port defined by the transceiver housing. A connector on the transceiver substrate is implemented as an array of pins that includes pinouts for the feedback devices. Finally, the transceiver module is configured to be mounted to a printed circuit board, such as a host bus adapter, so that an optoelectronic interface device is formed that is configured to implement an optical interface within a host device such as a computer.

### CROSS-REFERENCE TO RELATED APPLICATIONS

This application claims the benefit of U.S. Provisional Patent Application No. 60/520,896, filed on Nov. 17, 2003, entitled “Optical Transceiver with Integrated Light Emitting Diode Functionality,” incorporated herein in its entirety by this reference.

### BACKGROUND OF THE INVENTION

1. The Field of the Invention

This invention relates to optical components for use in an optical network. More particularly, embodiments of the invention are concerned with optical transceivers that incorporate integrated feedback devices, such as light emitting diodes.

2. Related Art

Fiber optic technology is increasingly employed as a vehicle by which information can be reliably transmitted via a communications network. Networks employing fiber optic technology are known as optical communications networks, and are marked by high bandwidth and reliable, high-speed data transmission.

Optical communications networks employ optical transceivers in transmitting information via the network from a transmission node to a reception node. Generally, such optical transceivers implement both data signal transmission and reception capabilities, such that a transmitter portion of a transceiver converts an incoming electrical data signal into an optical data signal, while a receiver portion of the transceiver converts an incoming optical data signal into an electrical data signal.

More particularly, an optical transceiver at the transmission node receives an electrical data signal from a network device, such as a computer, and converts the electrical data signal to a modulated optical data signal using an optical transmitter such as a laser. The optical data signal can then be transmitted in a fiber optic cable via the optical communications network to a reception node of the network. Upon receipt at the reception node, the optical data signal is fed to another optical transceiver that uses a photodetector, such as a photodiode, to convert the received optical data signal back into an electrical data signal. The electrical data signal is then forwarded to a host device, such as a computer, for processing.

Generally, multiple components are employed to accomplish different aspects of these functions. For example, an optical transceiver can include one or more optical subassemblies (“OSA”) such as a transmit optical subassembly (“TOSA”), and a receive optical subassembly (“ROSA”). Typically, each OSA is created as a separate physical entity, such as a hermetically sealed cylinder that includes one or more optical sending or receiving components, as well as electrical circuitry for handling and converting electrical signals into optical signals, and vice versa. Within the optical transceiver, each OSA generally includes electrical connections to various additional components such as a transceiver substrate, sometimes embodied in the form of a printed circuit board (“PCB”).

The transceiver substrate can include multiple other active circuitry components particularly designed to drive or handle electrical signals sent to or returning from one or more of the electrically-attached OSAs. Accordingly, such a transceiver substrate will usually include a number of electrical transmission lines with the one or more OSAs. Such connections may include “send” and “receive” data transmission lines for each OSA, one or more power transmission lines for each OSA, and one or more diagnostic data transmission lines for each OSA. These transmission lines are connected between the transceiver substrate and the OSA using different types of electrical connectors, examples of which include an electrical flex circuit, a direct mounting connection between conductive metallic pins extending from the OSA and solder points on the PCB, and a plug connection that extends from the PCB physically and electrically interfaces with the OSA.

In addition to the OSAs and other components noted above, some host bus adapters (“HBA”) and other system “boxes” further include feedback devices that provide visual feedback to a user concerning the operation and status of the transceiver module. Conventional feedback devices typically take the form of light emitting components such as light emitting diodes (“LED”s), which generally operate by selective transmission of light in order to indicate a certain type of component property.

For example, an LED that is intended to indicate a valid fiber optic connection may glow continuously if fiber optic cables are appropriately connected with the transceiver, or may be extinguished if there is a problem with the connection. As another example, an LED that is intended to indicate the occurrence of data transfer activity may blink on and off repeatedly for each given data packet that travels across the fiber optic cables into the transceiver.

The LED implementations in conventional HBAs and system boxes are exemplified by the use of a “light pipe” apparatus, as well as a direct solder mount of an LED to a board. In this type of configuration, the LED is mounted directly to the HBA. The first end of an optical wave guide such as a light pipe is optically coupled with the LED, and the second end of the optical waveguide is positioned, for example, near the front face of the transceiver module. Thus, light emitted by the LED is guided by the light pipe to the front face of the transceiver module, where the light is visible to a user.

In practice however, the LED and light pipe configuration has proven problematic. For example, the use of two separate components complicates the installation process and increases the overall cost of the optical transceiver. In particular, installation of the light pipes and LEDs necessitates additional steps in the manufacturing of the devices. Further, it can be difficult to properly align the LED with the light pipe so as to ensure that an adequate optical signal is transmitted out the end of the light pipe at the front face of the transceiver. Yet another concern is that the presence of the light pipe impairs the ability to maximize use of board space on the HBA or other board where the light pipe is employed.

Light pipe and LED configurations are especially problematic where compact devices such as small form factor (“SFF”), small form factor pluggable (“SFP”), and gigabit small form factor (“XFP”) fiber optic components, laptop network cards, and optical connector assemblies are concerned. More particularly, the light pipe and LED configuration is often too large to be employed. Consequently, such devices often simply do not employ feedback components. Among other things, this lack of feedback components impairs the ability of a user to assess the status and operation of the optical component.

Other implementations of feedback devices in HBAs and other system boxes are problematic as well. For example, another implementation involves the use of angled LEDs, so as to obviate the need for light pipes. While the use of light pipes can be eliminated in such implementations, the angled LED must still be mounted directly to the HBA or other board. Thus, circuit traces to connect the LED are required on the board and, further, the LED employs board space that could be used for other components. Thus, notwithstanding that this mounting arrangement of the LED enables a user to directly view the LEDs, mounting the LEDs in this way increases the cost and complexity of the optical transceiver.

In view of the foregoing, and other, problems in the art, what is needed are optical components with integrated feedback devices that provide useful and reliable feedback to a user concerning the operation and status of the optical component, while contributing to a relative increase in available board space. Such arrangements also eliminate production steps, thereby contributing to a relative improvement in manufacturing efficiency.

### BRIEF SUMMARY OF AN EXEMPLARY EMBODIMENT OF THE INVENTION

In general, exemplary embodiments of the present invention relate to feedback devices that conform to the space constraints dictated by compact optical component standards, while providing for a relative increase in available board space and obviating, in at least some instances, the need for additional circuitry in the optical component.

In one exemplary implementation, an optical transceiver module is provided that includes a transceiver housing within which a transceiver substrate and one or more optical sub-assemblies are situated. A transceiver substrate connector is provided that is implemented as a pin array that includes pinouts for first and second LED control lines. The first and second LED control line pins are in electrical communication with first and second LEDs positioned near a front face of the transceiver housing such that the LEDs can be observed by a user.

Thus, HBA board space is conserved, and the need for light pipes and other such structures obviated, by placing the LEDs at the front face of the transceiver housing. This arrangement also enables the use of LEDs or other indicators in small form factor devices. Further, incorporation of the LED pins in the transceiver substrate connector pinout enables use of the LED configuration in optical components that conform with MSA or other standards. These and other aspects of the present invention will become more fully apparent from the following description and appended claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A is a front view of an exemplary transceiver substrate and OSAs, showing an exemplary arrangement of a pair of feedback devices;

FIG. 1B is a rear view of an exemplary transceiver substrate and OSAs, showing an exemplary arrangement of a pair of feedback devices relative to other components mounted to the transceiver substrate;

FIG. 1C is a side view of a portion of an exemplary optical transceiver, showing an exemplary arrangement of OSAs, a pair of feedback devices, and a connector of the transceiver substrate;

FIG. 1D illustrates aspects of an exemplary transceiver substrate pinout that provides for the connection of a pair of feedback devices;

FIG. 2A is a top view of an exemplary transceiver module mounted on an HBA and including a pair of feedback devices;

FIG. 2B is a side view illustrating an arrangement of an exemplary transceiver module mounted to a board;

FIG. 2C is a front view of a transceiver module, showing an exemplary arrangement of a pair of feedback devices relative to the transceiver housing and a pair of OSAs, as viewed through connector ports defined by the transceiver housing;

FIG. 2D is a side view of a transceiver module, showing an exemplary arrangement of a feedback device relative to the transceiver housing and an OSA;

FIG. 3A is a rear view of an exemplary operating environment for an embodiment of an optical transceiver, namely, a desktop computer, indicating the position of the optical transceiver as well as the arrangement of corresponding feedback devices;

FIG. 3B is a side view of the exemplary operating environment indicated in FIG. 3A, showing a pair of optical cables and connectors as may be employed in connection with the operating environment; and

FIG. 3C is a perspective view of an alternative operating environment, specifically, a laptop computer, for exemplary embodiments of an optical transceiver module.

### DETAILED DESCRIPTION OF EXEMPLARY EMBODIMENTS OF THE INVENTION

In general, exemplary embodiments of the present invention relate to optical transceiver modules having integrated feedback components, such as LEDs for example, that are visible to a user. The integrated feedback components are typically mounted on the transceiver substrate so that board space on an associated board, such as an HBA for example, is conserved. Moreover, electrical connections to the feedback components are incorporated into the transceiver board pinout and are arranged to conform with a variety of different form factors and standards, one example of which is the MSA 2×5 pin arrangement.

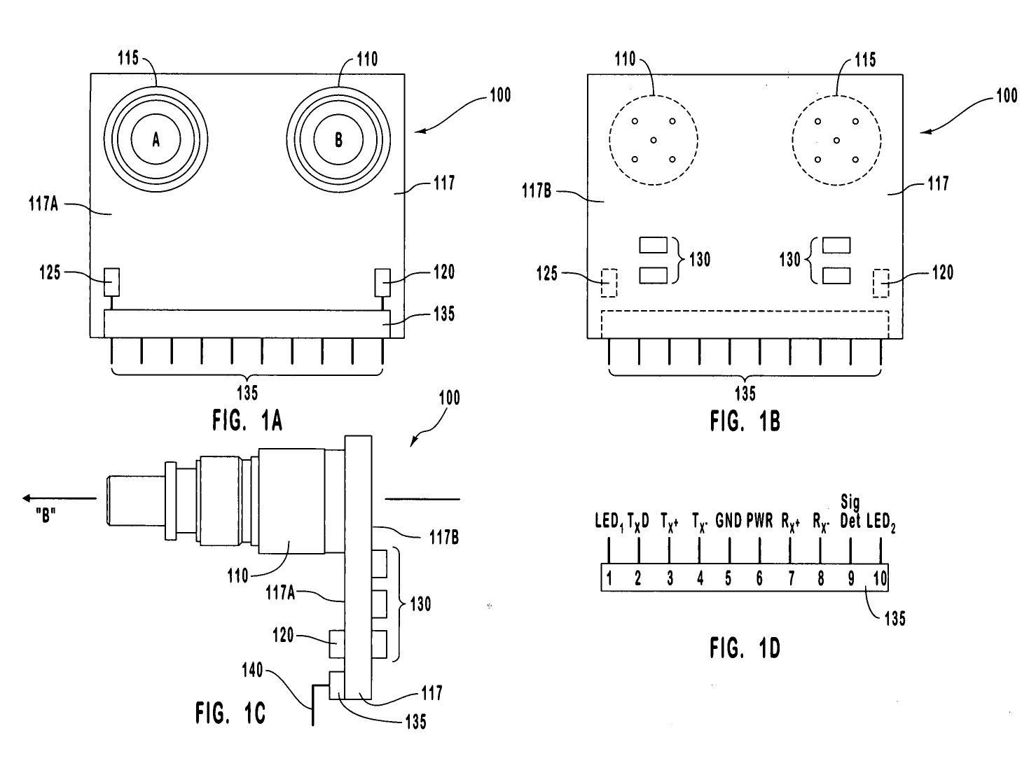

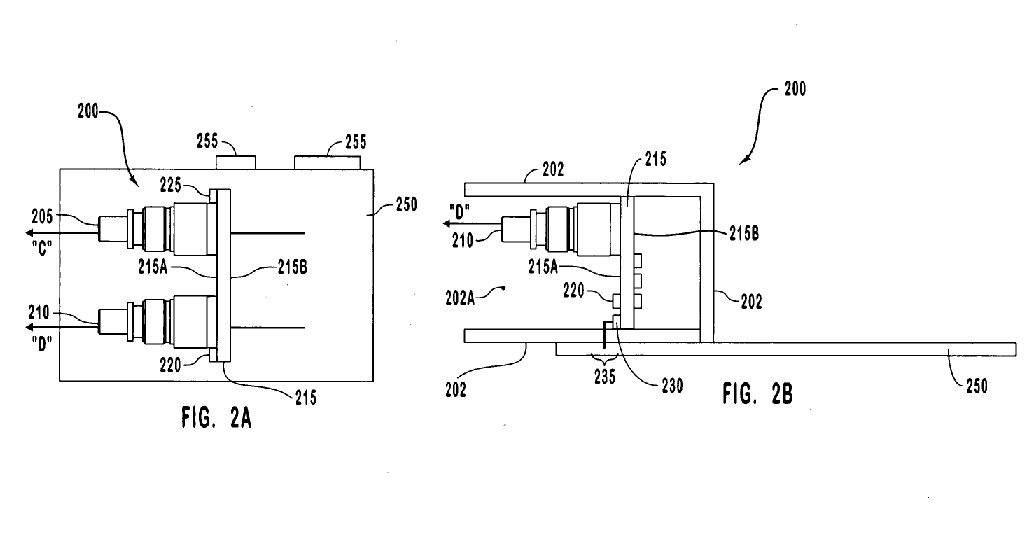

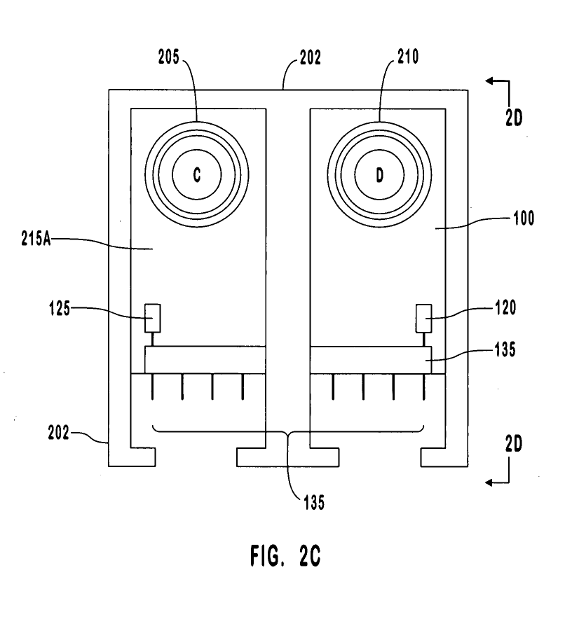

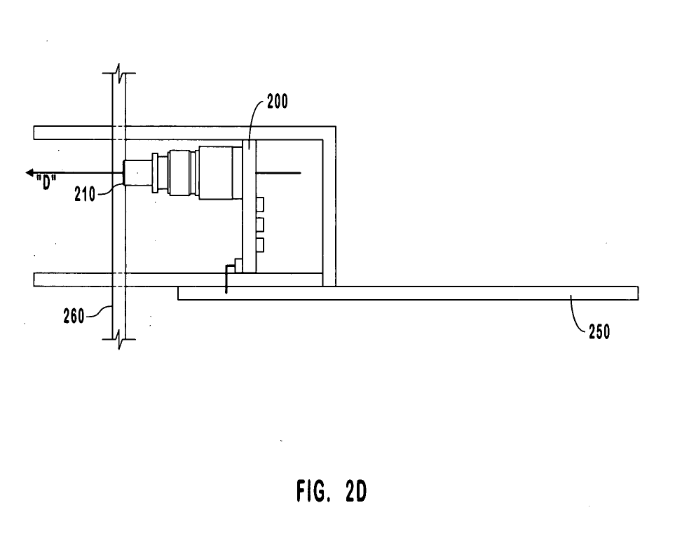

Directing attention now to FIGS. 1A through 1D, details are provided concerning an exemplary optical transceiver 100. The optical transceiver 100 includes a housing 202 (see FIG. 2C) within which is arranged a pair of OSAs 110 and 115. As used herein, an optical subassembly, or OSA, refers to any one of a transmit optical sub-assembly (“TOSA”) or a receive optical sub-assembly (“ROSA”) that can be used in a transceiver module.

The OSAs 110 and 115 are mounted to a transceiver substrate 117 which exemplarily takes the form of a printed circuit board (“PCB”) and has a front side 117A and a rear side 117B. Components mounted on exemplary transceiver substrates include, for example, laser drivers, memory components, and postamplifiers. In the illustrated implementation, the transceiver substrate 117 is arranged to be substantially perpendicular to longitudinal axes “A” and “B” respectively defined by OSAs 115 and 110. Exemplary implementations of transceiver substrates arranged in this way are disclosed and claimed in U.S. patent application Ser. No. ______ entitled COMPACT OPTICAL TRANSCEIVERS, (Workman Nydegger Docket No. 15436.374), filed on the same day herewith, and incorporated herein in its entirety by this reference.

Of course, other transceiver substrate configurations and orientations may be employed however. Accordingly, the scope of the invention is not limited to the exemplary disclosed embodiments.

Attached to the transceiver substrate 117 are a pair of feedback devices 120 and 125. Exemplarily, one or both of the feedback devices 120 and 125 comprises a visual feedback device, such as an LED for example. Other suitable feedback devices may be employed. Further, the type, number, positioning and orientation of the feedback devices may be varied as necessary to suit the requirements of the particular application. Accordingly, the disclosed implementations are exemplary only and are not intended to limit the scope of the invention in any way. It should be noted that as used herein, the term “feedback” refers generally to any information that is conveyed concerning the status, operation or other aspects of the optical transceiver and/or related systems, components, or devices.

The feedback can take any form, or forms, such as sensory indicia, suitable oz under the circumstances. In at least some implementations, the feedback is provided visually in the form of light. Different types of such visual feedback may be devised by varying, for example, the duration of the time that the light is transmitted, and the color of the light. Other types of visual feedback may be employed as well however.

In general, the feedback devices 120 and 125 are configured so that they receive electrical signaling by way of the electrical connector 135, discussed below. More particularly, signaling is provided to each feedback device 120 and 125 so that in the case where the feedback devices 120 and 125 are implemented as LEDs, the feedback devices 120 and 125 blink once each time a single data packet passes through an OSA. Alternatively, the feedback devices 120 and 125 remain illuminated so long as an optical link is operational, or may indicate link status, or the functioning of an OSA.

In the exemplary embodiment illustrated in FIGS. 1A through 1C, feedback devices 120 and 125 are placed on the front side 117A of the transceiver substrate 117. Generally, the feedback devices 120 and 125 are arranged so that they can be readily perceived by a user. For example, and as discussed in further detail below with regard to FIGS. 2C and 2D, feedback devices 120 and 125 are placed within a standard optical junction, such as an LC connection in a transceiver module, so that feedback devices 120 and 125 can still be seen by a user, notwithstanding the presence of one or more fiber cables and connectors. In some cases, the LC connection port on the transceiver module may be enlarged so as to define a gap through which a user can view the feedback devices 120 and 125.

With continuing reference to FIGS. 1A through 1D, and paying particular attention to FIGS. 1B and 1C, embodiments of the invention also provide for the mounting of various components to the rear side 117B of the transceiver substrate 117. By way of example, in some embodiments, only those components that are necessary either for connecting to the fiber optic network, driving the optical network communications, or indicating component status to a user are placed on the front side 117A of the transceiver substrate 117. Thus, in such an embodiment, the rear side 117B of the transceiver substrate is configured to, and does, include circuitry components 130 such as various capacitors and resistors. Other components, as well, may be mounted on the rear side 117B as space constraints require, such as, but not limited to, diagnostic circuitry, processors, and memory modules.

Directing particular attention now to FIG. 1D, and with continuing attention to FIGS. 1A through 1C, the transceiver substrate 117 further includes a connector 135 configured to electrically and mechanically interface with a corresponding connector or receptacle of an HBA or other board. Where the connector 135 is employed in an SFP module, the connector 135 can be repeatedly connected and disconnected. In other modules, such as SFF modules for example, the connector 135 is soldered or otherwise permanently attached to another board.

The connector 135 is exemplarily implemented as an array of pins 140 that includes pinouts 1 and 10 for feedback devices 125 and 120, respectively. In the illustrated exemplary implementation, pin 1 is designated LED, and pin 10 is designated LED₂. The remaining pins 2 through 9 correspond to standard functions, specifically: pin 2—TxDisable; pin 3—TxOut+; pin 4—TxOut−; pin 5—GND; pin 6—Power; pin 7—RxIn+; and, pin 8—RxIn−. In at least some implementations, the connector 135 is implemented as an MSA compliant array of pins.

By incorporating the feedback device pinouts, LED pinouts in this case, into the connector 135, the need for separate circuitry to connect components on the HBA, or other board, to the feedback devices of the optical transceiver is obviated. Further, because the connector 135 exemplarily conforms to MSA, or other, standards and form factors, embodiments of the optical transceiver can be readily employed in a variety of environments. In other implementations, such as an SFP module for example, signals are transmitted to the LEDs or other feedback devices by way of an I²C interface of the module. In this type of arrangement, the signals may originate from a host, or any other external system or device. Because the signals are transmitted to the feedback device by way of the I²C interface of the module, no new pins are required.

With attention now to FIGS. 2A through 2D, details are provided concerning aspects of an exemplary transceiver module 200 as employed in connection with a board, exemplarily implemented as an HBA 250, the combination of which may sometimes be referred to herein as an “optoelectronic interface device.” The HBA 250 may be any type of component, such as a PCB that connects to a computerized system through an edge connection, a serial connection, or a Small Computer System Interface (“SCSI”) connection.

As shown, the transceiver module 200 includes a housing 202 within which are disposed OSAs 205 and 210 mounted to a transceiver substrate 215, having front and rear sides 215A and 215B respectively, such that longitudinal axes “C” and “D” defined by the OSAs 205 and 210, respectively, are substantially perpendicular to the front side 215A of the transceiver substrate 215. The OSAs 205 and 210 are accessible by way of connector ports 202A defined by the housing 202. Feedback devices 220 and 225 are mounted to the front side 215A of the transceiver substrate 215 so as to be perceptible by a user, whether or not connectors are disposed in the connector ports 202A.

The transceiver substrate 215 additionally includes a connector 230 that is similar to the connector 135 illustrated in FIGS. 1A through 1D. Like connector 135, connector 230 exemplarily is implemented as an array of pins 235 that includes, for example, pinouts for feedback devices 220 and 225, respectively. In some cases, the connector 230 may be implemented as an MSA compliant array of pins.

In the illustrated implementation, the connector 230 is configured to connect directly to the HBA 250 such that the pins 235 physically and electrically interface with a corresponding connector (not shown) of the HBA 250. The connection between the HBA 250 and the connector 230 may be a repeatable connection, as in the case where connector 230 is employed in an SFP module or, alternatively, the connection between the HBA 250 and the connector 230 may be a permanent connection.

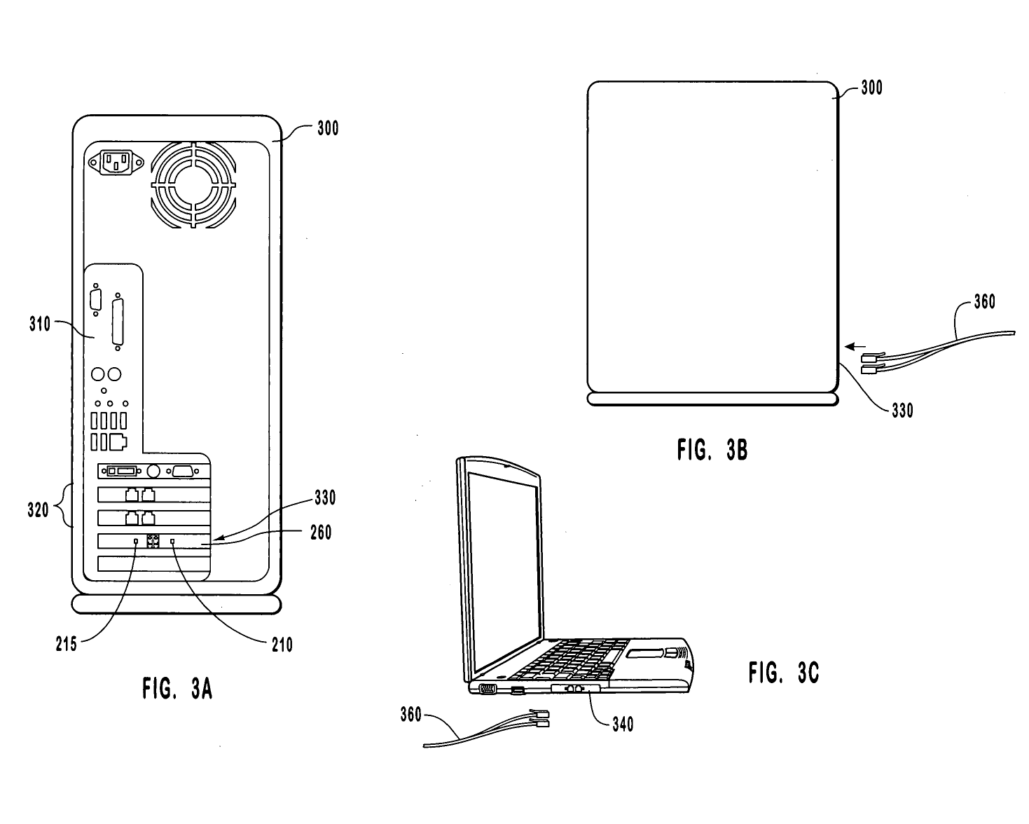

Among other things, the connection between the HBA and the transceiver module 200 enables implementation of an optical interface for the host device (see, e.g., FIGS. 3A through 3C) wherein the HBA 250 and transceiver module 200 are disposed. More particularly, in the exemplary implementation, the HBA 250 receives electrical power and/or signaling from a computerized system (see FIGS. 3A through 3C) by virtue of an additional connection interface such as through a SCSI connection, an edge connector 255, or through a Personal Computer Memory Card International Association (“PCMCIA”) slot. Thus, the computerized system, or other host device, can provide power and/or signaling to the feedback devices 220 and 225 by way of the HBA 250 and the connector 230.

As best illustrated in FIG. 2D, the optoelectronic interface device includes a faceplate 260 attached to the transceiver housing 202 and/or HBA 250 and defining suitable openings (see FIGS. 3A and 3C) for receiving optical fibers and connectors. Where the HBA 250 is implemented, for example, as a Peripheral Component Interconnect (“PCI”) card, the optoelectronic interface device can be operably received in a PCI card slot, available on a “mainboard” in a computerized system, and could interact with the host system by way of edge connectors 255.

In this exemplary case, the optoelectronic interface device would be largely hidden from the view of a user and primarily the faceplate 260, feedback devices 220 and 225, and OSAs 210 and 215 of the transceiver module 205 would be visible to the user. The OSAs 210 and 215, of course serve to connect the host device or system to an optical network, and the feedback devices 220 and 225 serve to provide a user with visual indicia as to status and/or operation of various components, systems and devices.

As suggested in FIGS. 3A, 3B, and 3C, embodiments of the transceiver module with integrated feedback devices can be implemented within various computerized systems and host devices. With reference to FIG. 3A, for example, a desktop computer 300 is shown that includes a component connection interface 310 that can have connection interfaces for a monitor, a keyboard, and other peripheral devices. The desktop computer 300 can also include one or more physical device or network communication interfaces 320 that can be connected within the desktop computer 300 through a PCI slot connection for example. Physical device or network communication interfaces 320 can include, among other things, Ethernet cable ports, telephone cable ports, as well as Universal Serial Bus (“USB”) or IEEE 1394 (Firewire) specification communication interfaces.

As further indicated in FIG. 3A, the desktop computer 300 is configured to operably receive an optoelectronic interface device 330 that exemplarily includes an HBA and transceiver module. When the optoelectronic interface device 330 is thus received, the face plate 260 is positioned and configured so that a user can access the communication ports for OSAs 210 and 215 (not shown), and so that a user can readily perceive feedback devices 210 and 215. With reference to FIG. 3B, a user can connect optical cables 360 into the optical communication ports through the openings defined in face plate 260. Similarly, as in FIG. 3C, the optoelectronic interface device 340 can be configured in a card such that the HBA is suitable to be slideably positioned into a laptop 350, such as through a PCI or PCMCIA card slot. Again, fiber optic cable 360 can plug directly to the optoelectronic interface device 340.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A transceiver module comprising:
a transceiver housing that defines at least one connector port;
a transceiver substrate substantially disposed within the transceiver housing and including a connector and circuitry;
at least one optical subassembly substantially disposed within the housing proximate the connector port and mounted at least indirectly to the transceiver substrate; and
at least one feedback device mounted to the transceiver substrate so as to be visible by way of the at least one connector port.

2. The transceiver module as recited in claim 1, wherein the at least one feedback device comprises an optical feedback device.

3. The transceiver module as recited in claim 1, wherein the at least one optical subassembly comprises at least one of: a receive optical sub-assembly; and, a transmit optical sub-assembly.

4. The transceiver module as recited in claim 1, wherein the at least one feedback device is visible by way of the at least one connector port regardless of whether or not a connector is present in the at least one connector port.

5. The transceiver module as recited in claim 1, wherein the connector of the transceiver substrate includes a pin in electrical communication with the at least one feedback device.

6. The transceiver module as recited in claim 1, wherein the connector of the transceiver substrate comprises a 2×5 pin array, at least one pin of which is in electrical communication with the at least one feedback device.

7. The transceiver module as recited in claim 1, further comprising an I²C interface by way of which the at least one feedback device is able to receive a signal from an external device.

8. A transceiver module comprising:
a transceiver housing that defines a pair of connector ports;
a transceiver substrate substantially disposed within the transceiver housing and including a connector comprising an array of pins;
a transmit optical subassembly and a receive optical subassembly substantially disposed within the housing proximate the connector port and mounted at least indirectly to the transceiver substrate; and
a pair of feedback devices mounted to the transceiver substrate, each of the feedback devices being visible by way of a corresponding connector port, and each of the feedback devices being in electrical communication with a corresponding pin of the connector.

9. The transceiver module as recited in claim 8, wherein at least one of the feedback devices comprises a light emitting diode.

10. The transceiver module as recited in claim 8, wherein each feedback device is visible by way of the corresponding connector port regardless of whether or not a connector is present in the corresponding connector port.

11. The transceiver module as recited in claim 8, wherein the connector of the transceiver substrate comprises a 2×5 pin array.

12. The transceiver module as recited in claim 8, wherein the transceiver module comprises one of: an SFP module; an SFF module; and, an XFP module.

13. The transceiver module as recited in claim 8, wherein the transmit optical subassembly and a receive optical subassembly each define a corresponding longitudinal axis, the transmit optical subassembly and a receive optical subassembly being mounted to the transceiver substrate such that the longitudinal axes are substantially perpendicular to a front side of the transceiver substrate.

14. An optoelectronic interface device, comprising:
a printed circuit board; and
a transceiver module attached to the printed circuit board and comprising:
a transceiver housing that defines at least one connector port;
a transceiver substrate substantially disposed within the transceiver housing and including a connector and circuitry;
at least one optical subassembly substantially disposed within the housing proximate the connector port and mounted at least indirectly to the transceiver substrate; and
at least one feedback device mounted to the transceiver substrate so as to be visible by way of the at least one connector port, and the at least one feedback device being in communication with the connector of the transceiver substrate

15. The optoelectronic interface device as recited in claim 14, wherein the printed circuit board comprises one of: a host bus adapter; and, a peripheral component interconnect board.

16. The optoelectronic interface device as recited in claim 14, wherein the transceiver module is removably attached to the printed circuit board.

17. The optoelectronic interface device as recited in claim 14, wherein the optoelectronic interface device is sized and configured to be operably received within an envelope defined by a host device, the envelope substantially conforming with dimensions of an interface device configured to receive a PCMCIA card.

18. The optoelectronic interface device as recited in claim 14, wherein the transceiver module comprises one of: an SFP module; an SFF module; and, an XFP module.

19. The optoelectronic interface device as recited in claim 14, wherein the at least one feedback device comprises a light emitting diode.

20. The optoelectronic interface device as recited in claim 14, wherein the at least one feedback device is visible by way of the connector port regardless of whether or not a connector is present in the connector port.

21. The optoelectronic interface device as recited in claim 14, wherein the connector of the transceiver substrate comprises a 2×5 pin array, at least one pin of which is in electrical communication with the at least one feedback device.

22. The optoelectronic interface device as recited in claim 21, wherein the 2×5 pin array is substantially MSA complaint.

23. The optoelectronic interface device as recited in claim 14, wherein the connector of the transceiver substrate includes a pin in electrical communication with the at least one feedback device.

24. The optoelectronic interface device as recited in claim 14, wherein the at least one optical subassembly comprises at least one of: a receive optical sub-assembly; and, a transmit optical sub-assembly.

25. The optoelectronic interface device as recited in claim 14, wherein the at least one feedback device comprises an optical feedback device.

26. The optoelectronic interface device as recited in claim 14, wherein the printed circuit board includes at least one edge connector.

27. The optoelectronic interface device as recited in claim 14, wherein the at least one feedback device is configured to communicate with circuitry of a host device when the optoelectronic interface device is operably connected with the host device.

28. The optoelectronic interface device as recited in claim 27, wherein the host system comprises one of: a desktop computer system; a laptop computer system; and, a personal digital assistant.

29. The optoelectronic interface device as recited in claim 14, further comprising a face plate defining an opening by way of which the connector port of the transceiver module is accessible, the at least one feedback device being visible by way of the opening defined in the face plate, and the face plate being attached to at least one of: the printed circuit board; and the transceiver module.
